(19) United States
(12) Patent Application Publication
(10) Pub. No.: US 2007/0030486 A1
(43) Pub. Date: Feb. 8, 2007

(54) Laser centering jig

(76) Inventor: Daniel Gelbart, (US)

Correspondence Address: DAN GELBART, 4706 DRUMMOND DR., VANCOUVER, BC, V6T-1B4, CA

(21) Appl. No.: 11/198,236

(22) Filed: Aug. 8, 2005

(51) Int. Cl. G01B 11/00

(52) U.S. Cl. 356/399

(57) ABSTRACT

The invention relies on the visual persistence of the human eye to perceive a circle when a laser spot is rotated rapidly. A diode laser spot projector is temporarily attached to the spindle of a machine tool and projects a sharp spot on the work piece. As the spindle rotates, an image of a circle is formed which is perfectly centered with the axis of rotation of the spindle. The work piece is moved until the projected circle lines up with the desired location for machining. The size of the projected circle can be changed by adjusting the position of the laser beam or by changing the distance between the spindle and work piece. The jig can accommodate a wide range of chuck and collet diameters.

### FIELD OF THE INVENTION

The invention relates to machine tools, in particular using a laser for aligning of a tool bit to a work piece.

### BACKGROUND OF THE INVENTION

Optical alignment methods are well known, including their use in machine tools. The invention of the laser, and in particular laser diodes, allowed a high brightness source to be used for improved visual alignment. Prior art use of lasers in machine tools, and in particular in drilling and milling machines, is based on projecting a laser spots or beams which are aligned with the center of rotation of the machine tool spindle. Since the centerline of the cut made by the tool bit (e.g. drill or milling cutter) coincides with the centerline of spindle rotation, aligning the spindle axis of rotation with the desired centerline of the feature to be cut will result in a correctly placed hole or cut.

Prior art methods require an accurate alignment of the laser to the spindle axis of rotation, or require complex sensors to detect laser beam position. Afterwards the laser can be used as an indicator of the centerline of the cut. Each time the alignment jig is removed the initial alignment may be lost. The situation is similar to aligning cross-hairs to the trajectory of a rifle, then placing the cross hairs on the target. Removal of the cross-hair target from the rifle and replacing it may require a new alignment to the rifle trajectory. It is the object of the present invention to provide a laser centering jig that does not require alignment to the machine tool axis. A second object is to provide a simple centering jig that can be mounted and removed from the spindle of a drill press or milling machine in seconds, regardless of the type of tool or tool holder used (i.e. chuck, collet etc The present invention does not require the removal of the cutting tool in order to use the centering jig, which is a major advantage.

### SUMMARY OF THE INVENTION

The invention relies on the visual persistence of the human eye to perceive a circle when a laser spot is rotated rapidly. A diode laser spot projector is temporarily attached to the spindle of a machine tool and projects a sharp spot on the work piece. As the spindle rotates, an image of a circle is formed which is perfectly centered with the axis of rotation of the spindle. The work piece is moved until the projected circle lines up with the desired location for machining.

The size of the projected circle can be changed by adjusting the position of the laser beam or by changing the distance between the spindle and work piece. The jig can accommodate a wide range of chuck and collet diameters.

### BRIEF DESCRIPTION OF THE DRAWINGS

FIG. 1 is a view showing the use of the invention on a machine tool.

FIG. 2 shows the cross-section of a device according to the invention.

FIG. 3-a and FIG. 3-B show how the invention is adaptable to a wide range of chuck or collet diameters

FIG. 4 shows an alternate embodiment of the invention.

### DETAILED DESCRIPTION OF THE PREFERRED EMBODIMENT

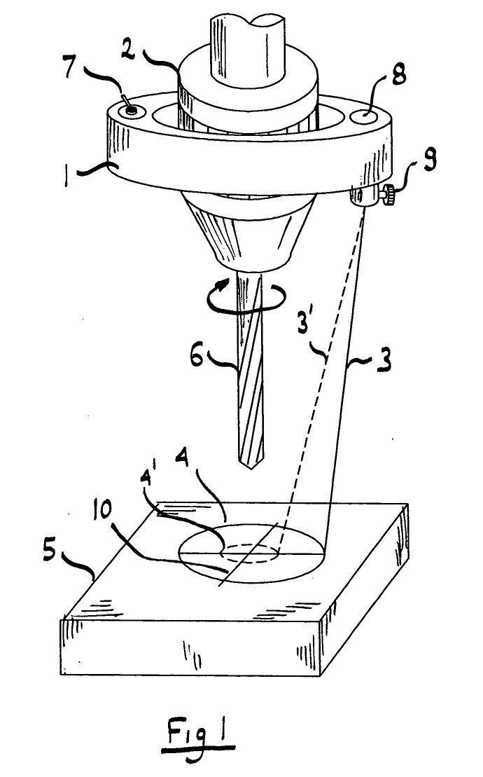

In FIG. 1 the centerline of cutting tool 6 held in chuck 2 has to be aligned with a feature 10 of work piece 5. Chuck 2 is mounted on a rotating spindle of a machine tool (not shown) such as a milling machine or drill press. Work piece 5 is normally clamped to the table of the machine tool and can be moved in two perpendicular directions. Since machine tools are well known, no details of the machine tool are shown. It is also clear that cutting tool 6 can be one of many different tools such as drill, reamer, tap, boring tool, end mill etc. It is also clear that chuck 2 can also be a collet, a boring head or any other means of holding a cutting tool to a rotating spindle.

Alignment jig 1 is temporarily clamped on chuck 2. Switch 7 turns on a laser diode beam projector 8. Beam position can be adjusted by screw 9. As beam is adjusted from position 3 to 3′ the circle formed when spindle is rotated will change from 4 to 4′. The exact size or position of circle are of no importance, as size of circle can be changed simply by moving rotating chuck 2 closer and further from the work piece. Centering of the circle with the axis of rotation of the spindle is not required, as the center of circle 4 will coincide with the axis of rotation, regardless of errors in mounting jig 1 on chuck 2. Work piece 5 is moved till projected circle 4 is concentric with the desired feature 10. At that point cutting tool 6 will cut at the center of feature 10 when spindle lowered.

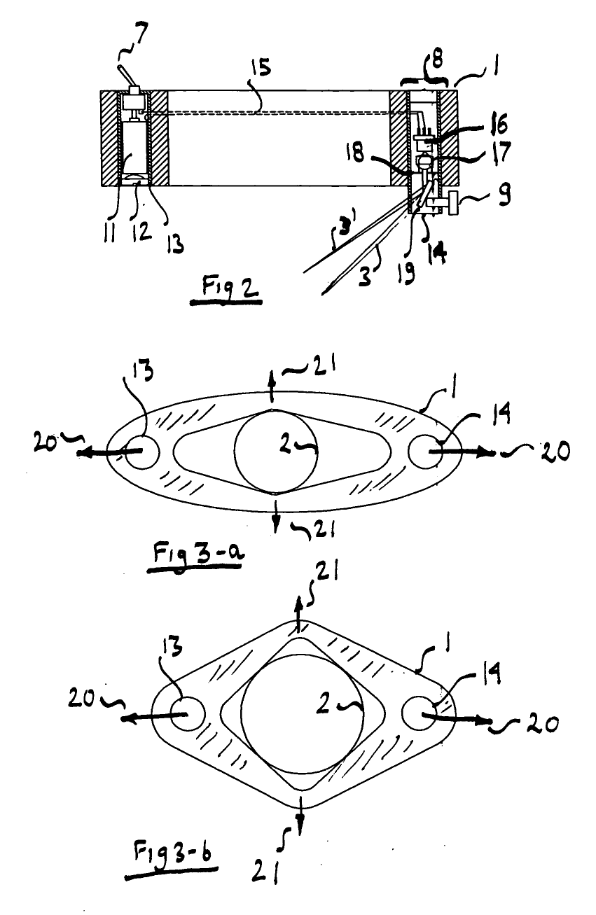

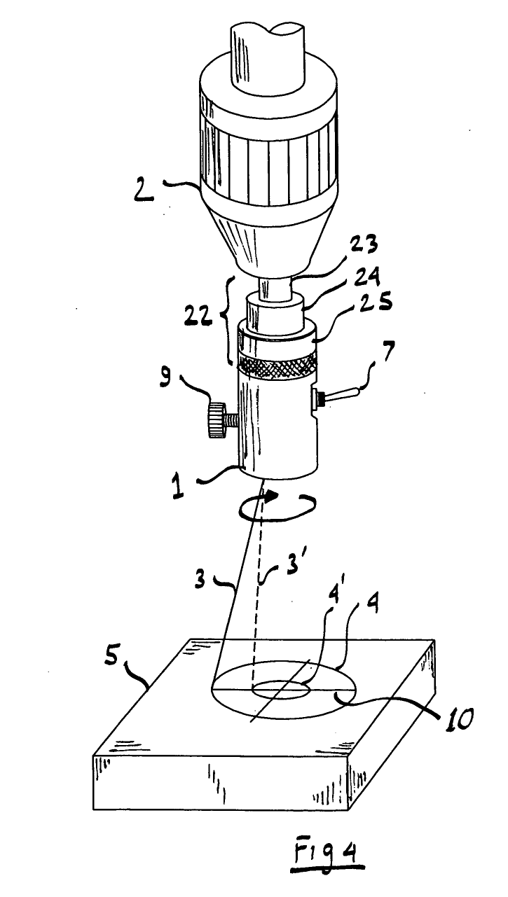

FIG. 2 is a cross section of the centering jig. In the preferred embodiment the body of the jig 1 is made from an elastomeric material in order to accommodate different chuck and collet sizes, as shown in FIG. 3-a and 3-b. By squeezing together the far ends of jig 1 the opening inside will increase. Two metal housings, 13 and 14, are encapsulated in the elastomeric material. Housing 13 contains battery 11, switch 7 and battery replacement access cover 12. The laser diode beam projector 8 is very similar to a common laser pointer: it comprises of housing 14, laser diode 16, lens 17, aperture 18, mirror 19 and adjustment screw 9. The battery 11 is connected to laser diode 17 via wires 15 embedded in the elastomeric material. A current limiting series resistor (or a more elaborate power control circuit) sets the laser diode power. Typical range is 1-5 mW. In order to keep the beam 3 in focus over a large range (i.e. to generate thin lines on the work piece over a wide range of distances) it is desired to work with f/# in the range of f/100-f/200. This requires an aperture 18 with a hole diameter of about 1.5-2 mm.

If desired mirror 19 can be replaced with reflective diffraction grating in order to generate multiple spots (and multiple circles). This eliminates the need for adjustment 9. Alternatively, a transmissive grating can be inserted in the beam pass, preferably at aperture 18. The grating should separate the orders by 5-25 degrees in order to generate a few spots. A good range for the grating is 150-800 lp/mm.

It is desired to place most of the mass of jig 1 at the far ends. This will cause the jig to tighten its grip as the spindle speed is increased, as the far ends will be subjected to a much stronger centrifugal force. Since the centrifugal force is proportional to both mass and radius, and both are larger at the far ends, the desired self-tightening effect is achieved. This is shown in FIG. 3-a and 3-b. The centrifugal forces 20 at the far end housings 13 and 14, causing increased grip, are much larger than the centrifugal forces 21, causing reduced grip. The jig should have a symmetrical shape and be well balanced to minimize vibrations at high speeds.

It is obvious that an elastomeric jig 1 is one on many possible designs to accommodate a large range of diameters. Other alternatives are pivoted rigid arms and double V-shaped rigid pieces held together by elastic energy such as springs.

By the way of example, jig 1 was made from castable polyurethane of medium durometer. The distance between housing 13 and 14 was about 120 mm and it accommodated chuck diameters from 25 to 65 mm. Laser diode 16 was a 3 mW 635 nm single mode diode, lens 17 was a molded plastic aspheric lens of f=4 mm, aperture 18 was 1.6 mm, lens was adjusted to focus bean to a small spot about 150 mm away. Battery 11 was a 3V lithium battery connected to laser diode via switch and 22 ohm series resistor. The laser diode and lens were identical to the ones used in laser pointers.

A simple, lower cost, embodiment is shown in FIG. 4. The disadvantage of this embodiment is that the cutting tool needs to be removed in order to mount the jig. To facilitate mounting, the top of the housing 22 is machined with a range of standard diameters 23, 24 and 25 (such as ¼″, ½″ and ¾″ or 6, 10 and 16 mm). The body of the jig 1 contains both the battery and laser diode.

What is claimed is:

1. A method for aligning the centerline of a rotating spindle to a feature in a work piece comprising the steps of:
temporarily mounting a laser spot projector onto said spindle in order to form a laser spot on work piece;
rotating said spindle at a speed sufficient for said spot to be perceived as a circle; and
aligning said circle with said feature.

2. A method as in claim 1 wherein said spindle carries a cutting tool and said projector can be mounted without removal of said cutting tool.

3. A method for aligning the centerline of a rotating spindle to a feature in a work piece comprising the steps of:
mounting a laser spot projector onto said spindle;
rotating said spindle at a speed sufficient for said spot to be perceived as a circle;
adjusting diameter of circle by changing distance from said spindle to said work piece; and
aligning said circle with said feature.

4. A method for aligning the centerline of a rotating spindle to a feature in a work piece comprising the steps of:
mounting a laser beam projector onto said spindle;
rotating said spindle at a speed sufficient for spot formed on work piece by said beam to be perceived as a circle; diameter of said circle adjustable by changing angle of said laser beam as well as by changing distance from said spindle to said work piece; and
aligning said circle with said feature.

5. A method as in claim 1 wherein more than one laser spot is projected onto said work piece.

6. A method as in claim 1 wherein said temporary mounting is achieved by the use of elastic energy.

7. A method as in claim 1 wherein said temporary mounting is achieved by clamping in a chuck.
